(19) United States
(12) Patent Application Publication
(10) Pub. No.: US 2011/0025159 A1
(43) Pub. Date: Feb. 3, 2011

(54) ROTOR ASSEMBLY INCLUDING SINTERED MAGNET CORE ASSEMBLY

(76) Inventor: Tim Wade, Rochester Hills, MI (US)

Correspondence Address: CARLSON, GASKEY & OLDS, P.C., 400 WEST MAPLE ROAD, SUITE 350, BIRMINGHAM, MI, 48009, US

(21) Appl. No.: 12/935,945

(22) PCT Filed: Apr. 10, 2009
(86) PCT No.: PCT/US2009/040143

§ 371 Date: Oct. 1, 2010

Related U.S. Application Data
(60) Provisional application No. 61/044,175, filed on Apr. 11, 2008.

(51) Int. Cl. H02K 1/27; H02K 15/03

(52) U.S. Cl. 310/156.28; 29/598

(57) ABSTRACT

A rotor assembly for an electric motor includes a drive assembly, a cup that receives a portion of the drive assembly, and a magnet core assembly received between the drive assembly and the cup. The magnet core assembly is hermetically sealed between the drive assembly and the cup.

### CROSS-REFERENCE TO RELATED APPLICATIONS

This application claims priority to U.S. Provisional Patent Application No. 61/044,175, filed Apr. 11, 2008.

### BACKGROUND OF THE INVENTION

This disclosure relates generally to an electric motor, and more particularly to a rotor assembly for an electric motor that includes a sintered magnet core assembly.

Electric motors support operation of pump assemblies, electronic appliances, and various other equipment. Electric motors typically include a rotor assembly and a stator assembly that partially surrounds the rotor assembly. The rotor assembly and the stator assembly cooperate to rotate a shaft to power an appliance.

For example, in electric motors that are used to power a pump assembly, the rotor assembly includes an impeller and a magnet core assembly that rotates the impeller to drive the pump assembly. Some electric motor driven pump assemblies utilize molded magnets within the magnet core assembly.

Other electric motors include rotor assemblies that have sintered magnets instead of molded magnets. Typically, the sintered magnet core assembly includes a plurality of magnets that are glued in place. Sintered magnet core assemblies can also include a fiberglass banding that is applied about the outer diameter of the sintered magnet core assembly to maintain a positioning of the magnets.

### SUMMARY OF THE DISCLOSURE

A rotor assembly for an electric motor includes a drive assembly, a cup that receives a portion of the drive assembly, and a magnet core assembly received between the drive assembly and the cup. The magnet core assembly is hermetically sealed between the impeller and the cup.

An electric motor includes a motor housing, a stator assembly that receives a portion of the motor housing, and a rotor assembly received by a portion of the motor housing. The rotor assembly includes a cup, a drive assembly and a magnet core assembly that is hermetically sealed between the cup and the drive assembly.

A method of providing a rotor assembly having a drive assembly, a cup and a magnet core assembly for an electric motor includes hermetically sealing the magnet core assembly between the cup and the drive assembly. The magnet core assembly is magnetized subsequent to the step of hermetically sealing the magnet core assembly.

### BRIEF DESCRIPTION OF THE DRAWINGS

The various features and advantages of this disclosure will become apparent to those skilled in the art from the following detailed description. The drawings that accompany the detailed description can be briefly described as follows.

FIG. 1A illustrates an exploded view of an example electric motor;

FIG. 1B illustrates another exploded view of the example electric motor of FIG. 1A;

FIG. 2A illustrates a perspective view of an example rotor assembly of the electric motor illustrated in FIG. 2A;

FIG. 2B illustrates a cross-sectional view of the example rotor assembly illustrated in FIG. 2A;

FIG. 2C illustrates an assembly view of the example rotor assembly illustrated in FIG. 2A;

FIG. 3 illustrates an example sintered magnet of a magnet core assembly of the rotor assembly illustrated in FIGS. 2A-2C; and

FIG. 4 illustrates another example rotor assembly for use with an electric motor.

### DETAILED DESCRIPTION OF THE DISCLOSED EMBODIMENT

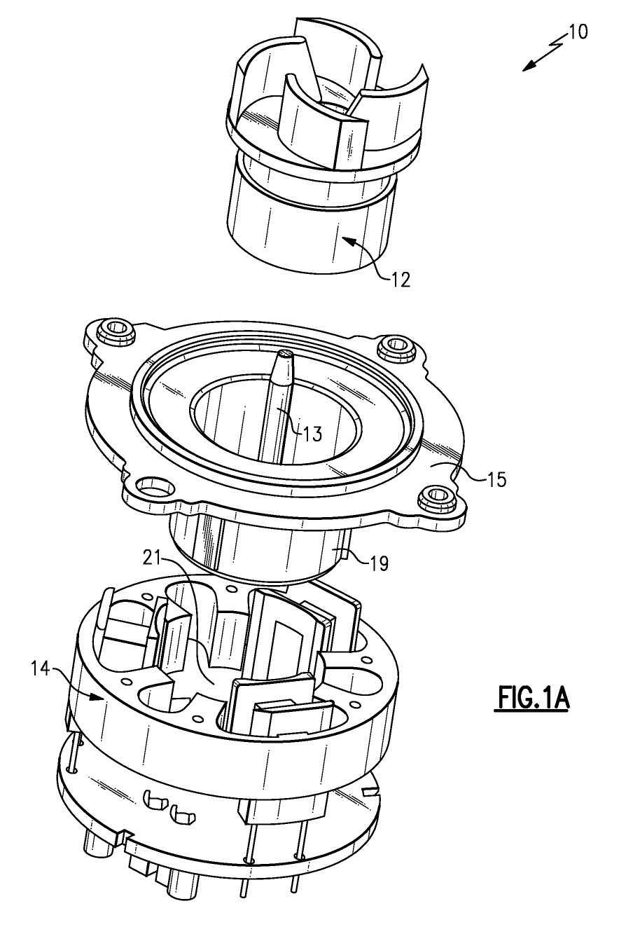

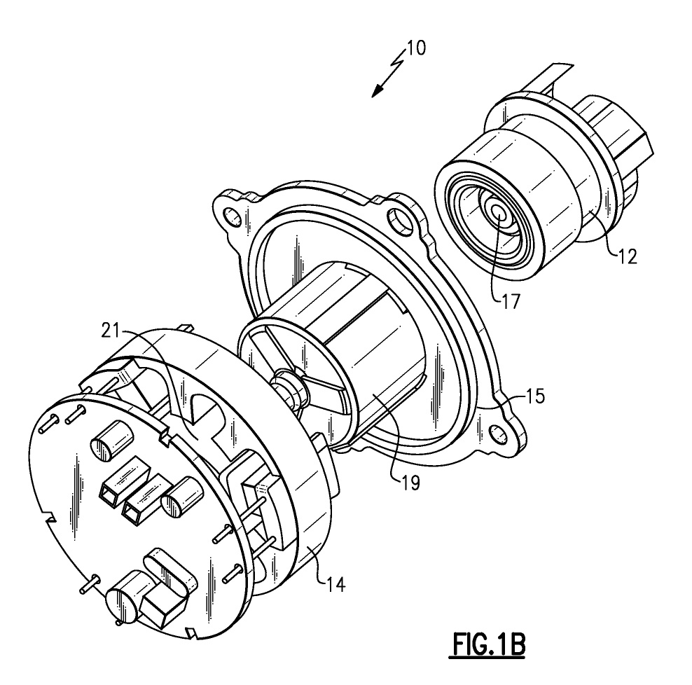

FIGS. 1A and 1B illustrate an example electric motor 10. In one example, the electric motor 10 is a brushless direct current motor (BLDC). It should be understood that the various illustrations and examples described within this disclosure are not limited to any particular motor. That is, this disclosure is applicable to any type of electric motor.

The electric motor 10 includes a rotor assembly 12, a stator assembly 14, and a motor housing 15. The rotor assembly 12 is received by the motor housing 15. In this example, a shaft 13 extends through a passage 17 of the rotor assembly 12 to receive the rotor assembly 12. The stator assembly 14 receives and partially surrounds the motor housing 15 on an opposite side of the motor housing 15 from the rotor assembly 12. For example, a flange 19 of the motor housing 15 is received within a corresponding recess 21 of the stator assembly 14. The motor housing 15 isolates the electronics of the electric motor 10 from fluid, such as coolant.

The electric motor 10 operates in a known manner and is applicable for use within a variety of electronic appliances. For example, the electric motor 10 is operable to drive a pump assembly. Although the various features and advantages of this disclosure are described in relation to a pump assembly, it should be understood that the electric motor 10 is operable for use with any appliance.

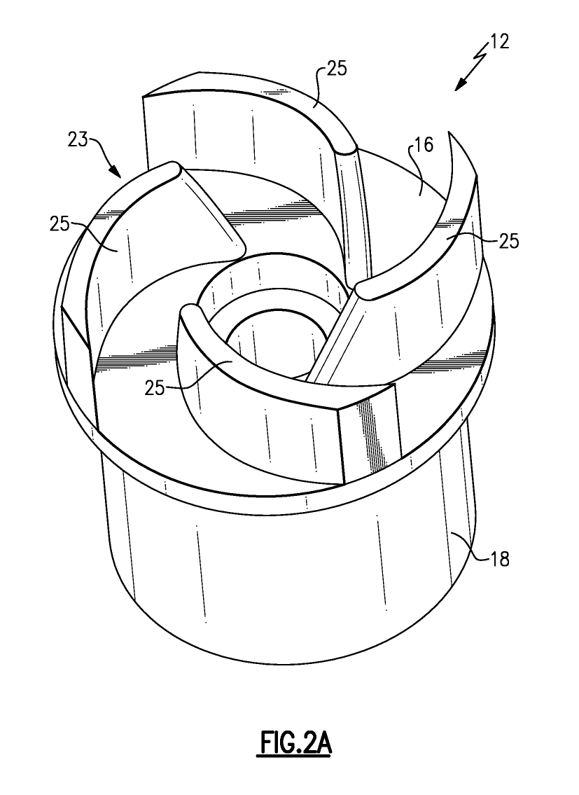

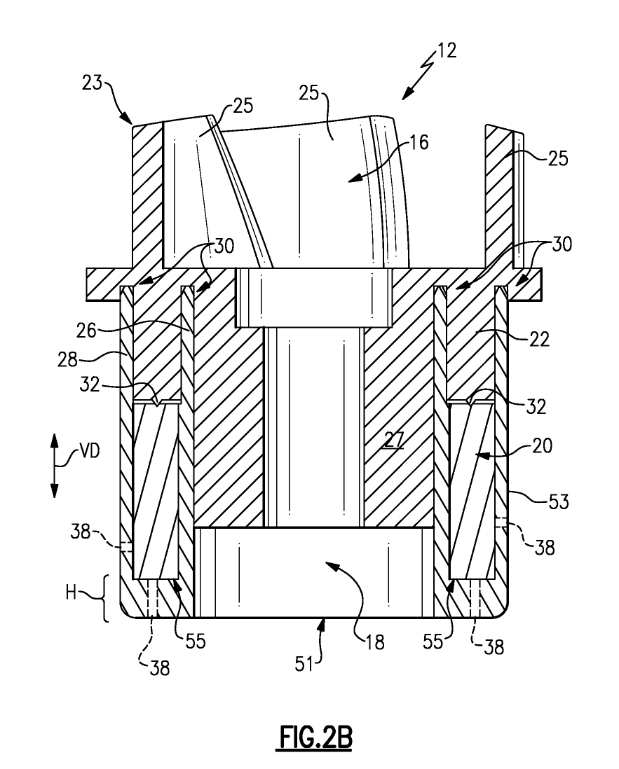

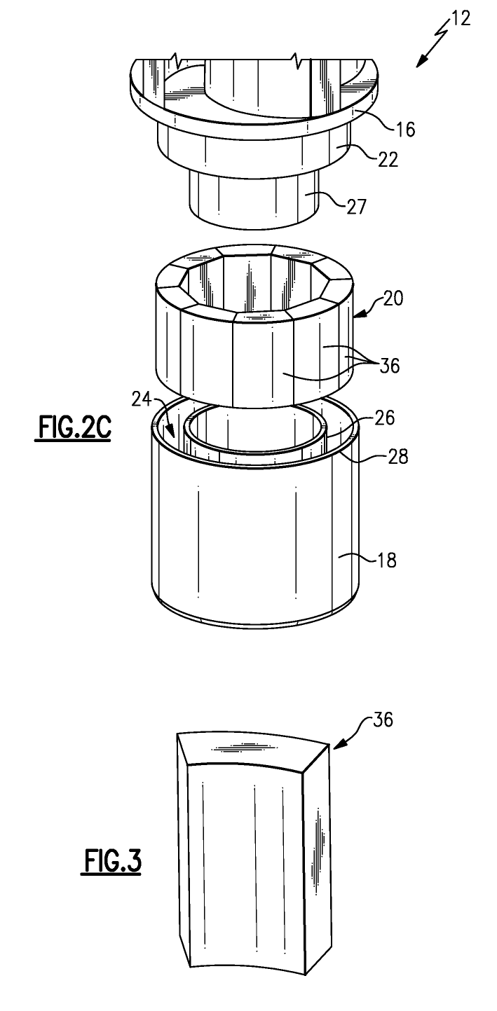

FIGS. 2A-2C illustrate an example rotor assembly 12 for use within the electric motor 10. The rotor assembly 12 includes a drive assembly 23, such as an impeller 16, a cup 18, and a magnet core assembly 20. In one example, the impeller 16 and the cup 18 are plastic parts. A person of ordinary skill in the art having the benefit of this disclosure would be able to select an appropriate material for the impeller 16 and the cup 18.

The magnet core assembly 20 is hermetically sealed between the cup 18 and the impeller 16, as is further discussed below. The magnet core assembly 20 rotates the impeller 16 to drive a pump assembly, for example. The impeller 16 includes a plurality of blades 25 that pump a fluid, such as coolant, within a pump assembly.

The impeller 16 further includes a first flange 22 that is partially received within an opening 24 of the cup 18 to assemble the rotor assembly 12. The opening 24 extends between an inner cylinder 26 and an outer cylinder 28 of the cup 18. In this example, the outer cylinder 28 extends radially outward from the inner cylinder 26. The impeller 16 also includes a second flange 27 that is received within the inner cylinder 26 of the cup 18. The magnet core assembly 20 is received within the opening 24 and is partially positioned between the cup 18 and the impeller 16.

The impeller 16 is attached to the cup 18 to provide an environmental seal that protects the magnet core assembly 20 from coolant and other harsh fluids that are communicated within a pump assembly. In one example, the impeller 16 and the cup 18 are adjoined in a spin welding process. In a spin welding process, the two separate parts are received by a fixture and are rotated relative to one another. The relative rotation creates heat and friction between the two parts. The heat and friction melts the plastic parts together to adjoin the impeller 16 and the cup 18. In another example, the impeller 16 and the cup 18 are joined in an ultrasonic fastening method. It should be understood that any fastening method may be utilized to adjoin the impeller 16 and the cup 18.

A plurality of joints 30 are formed at an interface between the impeller 16 and the cup 18. In this example, the joints 30 are provided at the interface between the flange 22 of the impeller 16 and each of the inner cylinder 26 and the outer cylinder 28 of the cup 18 (Four joint 30 locations illustrated in FIG. 2B). The flange 22 of the impeller 16 includes a plurality of positioning blades 32 that lock the magnet core assembly 20 in a vertical direction VD when assembled.

The magnet core assembly 20 includes a plurality of magnets 36 (See FIG. 2C). In one example, the magnets 36 are sintered magnets. The sintered magnets 36 are formed by compression molding metallic particles to form a coherent mass. Each magnet 36 is positioned adjacent another magnet 36 having an opposite polarity. In this example, the magnet core assembly 20 includes ten magnets 36. However, the actual number, size and shape of the magnets 36 will vary depending upon design specific parameters including, but not limited to, the torque and power requirements of the electric motor 10. A person of ordinary skill in the art having the benefit of this disclosure would be able to select an appropriate number of magnets for satisfactory use of the magnet core assembly 20 within any application.

The magnet core assembly 20 is received within the opening 24 of the cup 18 prior to adjoining the impeller 16 and the cup 18. That is, the magnet core assembly 20 is received between the impeller 16 and the cup 18, and is hermetically sealed therebetween. The magnetic core assembly 20 is magnetized subsequent to the hermetic sealing of the impeller 16 relative to the cup 18. The cup 18 includes a plurality of openings 38 that provide access to the magnets 36 of the magnet core assembly 20 to magnetize the magnet core assembly 20 subsequent to assembly of the rotor assembly 12 (See FIG. 2B). The openings 38 may be formed through a bottom portion 51 of the cup 18, a side wall 53 of the cup 18, or through both the bottom portion 51 and the side wall 53 of the cup 18.

The cup 18 further defines a flat portion 55 (See FIG. 2B) that extends between the inner cylinder 26 and the outer cylinder 28. The flat portion 55 supports the magnet core assembly 20 on an opposite end of the magnet core assembly 20 from that portion of the magnet core assembly 20 that contacts the positioning blades 32 of the flange 22 of the impeller 16. The flat portion 55 dictates a height H of the magnet core assembly 20 relative to the bottom portion 51 of the cup 18 and, in conjunction with the positioning blades 32, locks the magnet core assembly 20 in a vertical direction VD when assembled.

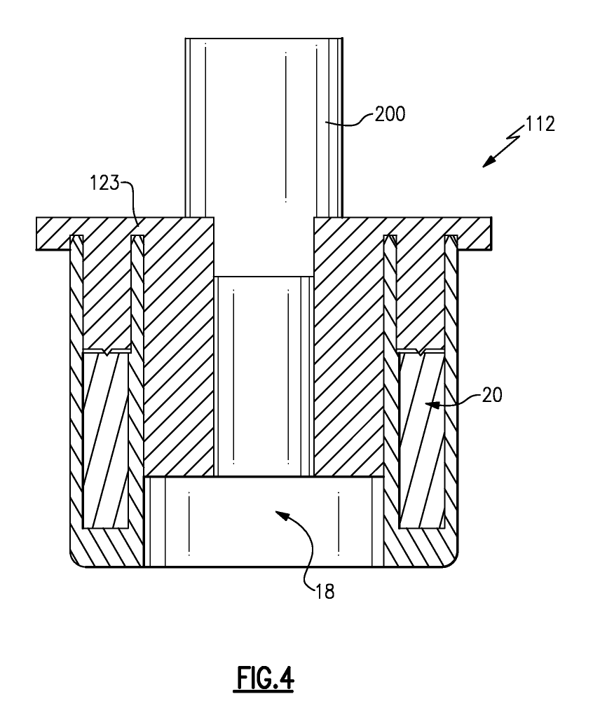

FIG. 3 illustrates an example sintered magnet 36 of the magnet core assembly 20. In one example, the sintered magnet 36 is generally bread-loaf shaped. However, the actual shape of each magnet 36 will depend upon the design and shape of the opening 24 and the cup 18, for example.

In one example, the magnets 36 are sintered and include Neodynium that is molded into blocks and cut into pieces by an electro-discharge machining process. In yet another example, the magnets are formed from NdFeB compounds. The magnets 36 are formed from metallic particles in a compression molding process, for example.

FIG. 4 illustrates another example rotor assembly 112 that includes a drive assembly 123 that does not include an impeller 16. Rather, the rotor assembly 112 includes a shaft 200 that is driven to power an appliance, for example. In this disclosure, like reference numerals designate like elements where appropriate, and reference numerals with the addition of 100 or multiples thereof designate modified elements. It is to be understood that the modified elements incorporate the same features and benefits of the corresponding original elements, except where stated otherwise. The various features and advantages identified above with respect to the rotor assembly 12, including but not limited to the cup 18, the magnet core assembly 20 and the sintered magnets 36, are equally applicable to the rotor assembly 112.

The foregoing description shall be interpreted as illustrative and not in any limiting sense. A worker of ordinary skill in the art having the benefit of this disclosure would understand that certain modifications would come within the scope of this disclosure. For these reasons, the following claims should be studied to determine the true scope and content of this disclosure.

What is claimed is:

1. A rotor assembly for an electric motor, comprising:
a drive assembly;
a cup that receives a portion of said drive assembly; and
a magnet core assembly received between said drive assembly and said cup, wherein said magnet core assembly is hermetically sealed between said drive assembly and said cup.

2. The rotor assembly as recited in claim 1, wherein said drive assembly includes an impeller.

3. The rotor assembly as recited in claim 1, wherein said drive assembly includes a shaft.

4. The rotor assembly as recited in claim 1, wherein said magnet core assembly includes a plurality of sintered magnets.

5. The rotor assembly as recited in claim 4, wherein said plurality of sintered magnets are generally bread-loaf shaped.

6. An electric motor, comprising;
a motor housing;
a stator assembly that receives a portion of said motor housing; and
a rotor assembly received by a portion of said motor housing, wherein said rotor assembly includes a cup, a drive assembly and a magnet core assembly hermetically sealed between said cup and said drive assembly.

7. The electric motor as recited in claim 6, wherein said cup includes an inner cylinder and an outer cylinder that is positioned radially outward from said inner cylinder.

8. The electric motor as recited in claim 7, wherein an opening extends between said inner cylinder and said outer cylinder, and said magnet core assembly is received within said opening.

9. The electric motor as recited in claim 7, wherein said cup includes a flat portion that extends between said inner cylinder and said outer cylinder on an opposite end of said cup that receives said drive assembly.

10. The electric motor as recited in claim 6, wherein said magnet core assembly includes a plurality of sintered magnets.

11. A method of providing a rotor assembly having a drive assembly, a cup and a magnet core assembly for an electric motor, comprising the steps of:
(a) hermetically sealing the magnet core assembly between the cup and the drive assembly; and
(b) magnetizing the magnet core assembly subsequent to the step of hermetically sealing the magnet core assembly.

12. The method as recited in claim 11, comprising:
(c) providing openings through the cup to provide access to the magnet core assembly for magnetizing the magnet core assembly.

13. The method as recited in claim 11, wherein the magnet core assembly includes a plurality of sintered magnets.

14. The method as recited 13, comprising the step of:
(c) forming each of the plurality of sintered magnets into generally bread-loaf shapes.

15. The method as recited in claim 11, wherein said step (a) includes:
spin welding the cup and the drive assembly to provide the hermetic seal.
